(19) United States
(12) Patent Application Publication
(10) Pub. No.: US 2003/0167350 A1
(43) Pub. Date: Sep. 4, 2003

(54) Safe I/O through use of opaque I/O objects

(75) Inventors: Donald T. Davis, Somerville, MA (US); David A. Kranz, Arlington, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Curl Corporation, Cambridge, MA

(21) Appl. No.: 10/163,095

(22) Filed: Jun. 4, 2002

Related U.S. Application Data
(60) Provisional application No. 60/297,093, filed on Jun. 7, 2001.

(51) Int. Cl. G06F 9/00; G06F 15/16

(52) U.S. Cl. 709/316; 709/203

(57) ABSTRACT

Opaque I/O objects are described which can be used in a variety of mobile code systems to permit unprivileged applets to perform a wide variety of I/O operations in a safe manner. Such opaque objects permit limited I/O without requiring the user of an applet to confer trust or privilege on the applet, and without exposing the user to a risk of his data being destroyed, compromised, or stolen by malicious applets.

### RELATED APPLICATION(S)

This application claims the benefit of U.S. Provisional Application No. 60/297,093, filed on Jun. 7, 2001. The entire teachings of the above application(s) are incorporated herein by reference.

### BACKGROUND OF THE INVENTION

The growth of the Internet has led to the development of numerous technologies for the distribution of content over the World Wide Web. Among these technologies are systems that permit Web content to include executable code, that is sent from a Web server to a Web client, where it is executed. Such “mobile code” or “applets” allow content providers to distribute content that includes programmed behavior, which may be used in a variety of ways. Mobile code systems, such as Java, produced by Sun Microsystems, of Palo Alto, Calif., or Curl, provided by Curl Corporation, of Cambridge, Mass., may greatly enhance the experience of Web users by providing a relatively efficient way for highly interactive or media-rich content to be sent across the Web.

It is often necessary for mobile code to perform input and/or output (I/O) operations, such as displaying images on the display of the computer that downloaded the code, printing data, receiving input from a microphone, accessing a network, playing music from CD players, or accessing files on a local disk. These types of I/O operations raise serious security concerns, especially when performed by mobile code, which is downloaded over the Internet, and which could easily include malicious code designed to damage or steal data from a user's computer. If mobile code were permitted to have full access to such a wide variety of I/O functions, users of the mobile code would be exposed to a wide variety of attacks and to theft of data.

Some mobile code systems have attempted to mitigate this problem by providing a way for providers of mobile code to mark their code as “safe”, giving the user some assurance that his data will not be damaged or stolen if he executes mobile code that has been marked “safe” by an entity that he trusts. This type of system is used in the Shockwave system by Macromedia, Microsoft's ActiveX, Java by Sun Microsystems, and Javascript.

Microsoft's Authenticode technology is typical of such marking or signing mechanisms. Using Authenticode, the author of an applet digitally signs the applet. When the browser downloads the applet, the browser verifies the digital signature to ensure that the applet has not been tampered with, and the browser asks the user whether he wishes to trust the author of the applet, and to permit the applet to execute. If the user is willing to trust the author of the applet, the applet is given free access to the user's computer. In theory, if a signed applet causes harm, the digital signature identifies the entity that created the harmful applet, so they can be held responsible.

Although these marking and signing mechanisms are better than having no security, they are not sufficient. First, code that is capable of damaging data on a user's computer, or of creating security holes that can be exploited by other mobile code, is not always written on purpose. Such code is often written accidentally, and distributed without knowledge of the flaws in the code. There have been occasions where code that could be harmful has been unwittingly written, signed, and distributed by very credible vendors, whom users would likely choose to trust.

Additionally, as applets and other mobile code become more pervasive on the Web, a typical user may access applets from hundreds of different sources. It is unrealistic to expect the user to be able to evaluate each of these distributors of applets to determine whether they are worthy of trust. Although it has been suggested that this problem could be solved by having a few “trusted” applet security testing and certification sources that would test applets and digitally sign them to indicate that they are safe, no such security testing and certification source currently exists, and there is no evidence to suggest that any will soon be created.

Further, the notion that a harmful applet will necessarily be traceable back to its author, so that he may be held responsible, may be flawed. In an environment where the user has downloaded and agreed to trust numerous applets in a given session, it may not be possible for the user to determine exactly which of them destroyed his data. Additionally, accountability by signing does little to deter theft of data, since such theft may go completely undetected by users of an applet that has been permitted to fully access a user's system.

### SUMMARY OF THE INVENTION

It is therefore desirable to provide a system and methods that permit limited, safe access to I/O functions by mobile code, without requiring that users of the applets grant broad permission for such mobile code to perform all I/O operations. Specifically, it would be desirable to allow mobile code to perform some limited local I/O operations on a user's computer, without having to: (i) ask the user for permission; (ii) require special configuration of the user's system, such as granting access or setting up access lists; (iii) give mobile code unfettered access to I/O operations, so that such code is able to steal or damage local data; (iv) require that the applet's author be identified as a trusted entity; or (v) require the user to maintain access control on applet authors or applets that are allowed to perform local I/O operations.

A method is provided for safely permitting limited operations by untrusted or unprivileged applets in an object-oriented computer system by defining objects that provide for classifying data and methods performing input operations or output operations on the data to limit access to the input operations, the output operations or the data. The objects are then used to control access to the input operations, the output operations or the data.

In one embodiment, the object-oriented computer system is a mobile code computer system. The control comprises restricting access, notifying a user prior to accessing, or receiving authorization from a user prior to accessing, at least one of the input operations, the output operations and the data. Input operations can be classified as sensitive or non-sensitive, or as loud or silent. Output operations can be classified as low-risk or high-risk, or immediate or delayed. Data can be classified as accessible or locked. The objects can also be used to control access to the input operations or the output operations and the data through events. The events can be classified as authentic or synthetic.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram of a computer system on which an embodiment of the present invention is implemented.

FIG. 2 is a diagram of the internal structure of a computer in the computer system of FIG. 1.

FIG. 3 illustrates the process for safely permitting limited operations by untrusted or unprivileged applets in an object-oriented computer system.

### DETAILED DESCRIPTION OF THE INVENTION

A description of preferred embodiments of the invention follows. The present invention provides a system and methods that permit mobile code to perform limited local I/O operations without requiring that the mobile code be granted privileges or trust by the user of the mobile code. This is achieved by permitting mobile code to access local I/O operations only through specially defined “opaque data objects.” Such “opaque data objects” (or “opaque objects” or “objects”) mark certain data and methods in objects that provide access to I/O in an object oriented system as “private” or “privileged”, so that an unprivileged applet has only limited access to objects that provide access to I/O. Such unprivileged (or untrusted) applets are able to access I/O operations through the opaque object, but only in a tightly constrained way, to prevent unprivileged applets or other mobile code to damage or steal data from the user's computer.

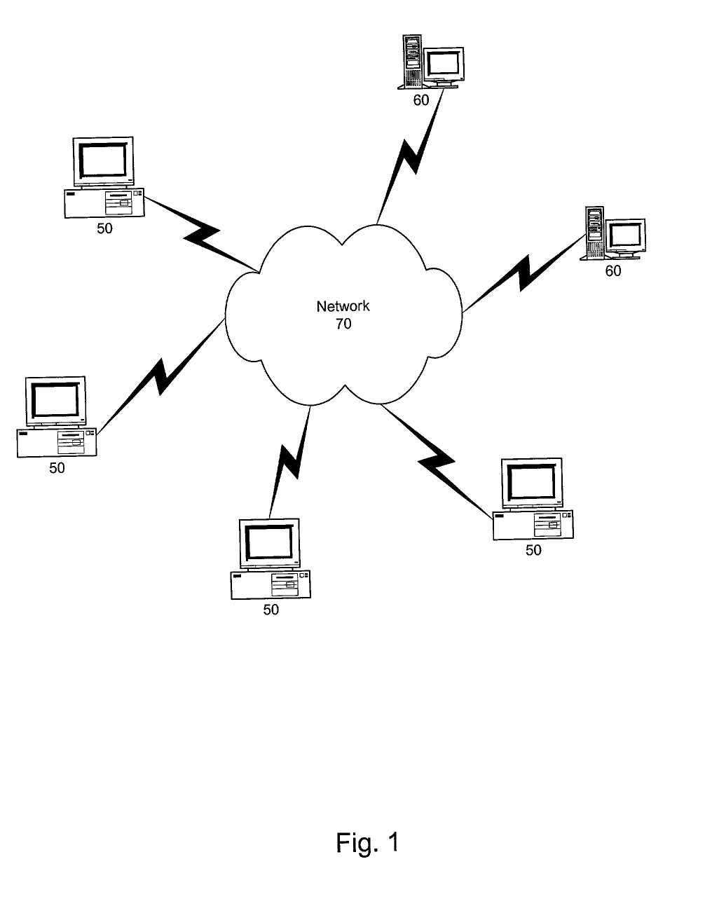

FIG. 1 is a diagram of a computer system on which an embodiment of the present invention is implemented. Client computer 50 and server computer 60 provide processing, storage, and input/output devices for safely permitting limited operations by untrusted or unprivileged applets in an object-oriented computer system. The client computers 50 can also be linked through a communications network 70 to other computing devices, including other client computers 50 and server computers 60. The communications network 70 can be part of the Internet, a worldwide collection of computers, networks and gateways that currently use the TCP/IP suite of protocols to communicate with one another. The Internet provides a backbone of high-speed data communication lines between major nodes or host computers, consisting of thousands of commercial, government, educational, and other computer networks, that route data and messages. In another embodiment of the present invention, the processing, storage, and input/output devices for safely permitting limited operations by untrusted or unprivileged applets in an object-oriented computer system can be implemented on a stand-alone computer.

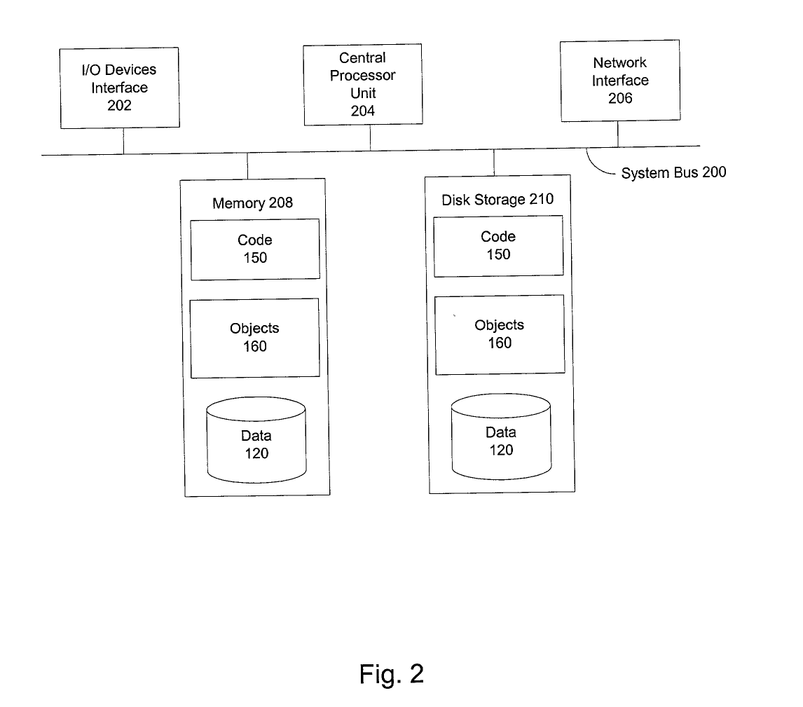

FIG. 2 is a diagram of the internal structure of a computer (e.g., 50, 60) in the computer system of FIG. 1. Each computer contains a system bus 200, where a bus is a set of hardware lines used for data transfer among the components of a computer. A bus 200 is essentially a shared conduit that connects different elements of a computer system (e.g., processor, disk storage, memory, input/output ports, network ports, etc.) that enables the transfer of information between the elements. Attached to system bus 200 is an I/O device interface 202 for connecting various input and output devices (e.g., displays, printers, speakers, etc.) to the computer. A network interface 206 allows the computer to connect to various other devices attached to a network (e.g., network 70). A memory 208 provides volatile storage for computer software instructions (e.g., code 150 and objects 160) and data structures (e.g., data 120) used to implement an embodiment of the present invention. Disk storage 210 provides non-volatile storage for computer software instructions (e.g., code 150 and objects 160) and data structures (e.g., data 120) used to implement an embodiment of the present invention.

A central processor unit 204 is also attached to the system bus 200 and provides for the execution of computer instructions (e.g., code 150 and objects 160), thus allowing the computer to safely permit limited operations by untrusted or unprivileged applets in an object-oriented computer system.

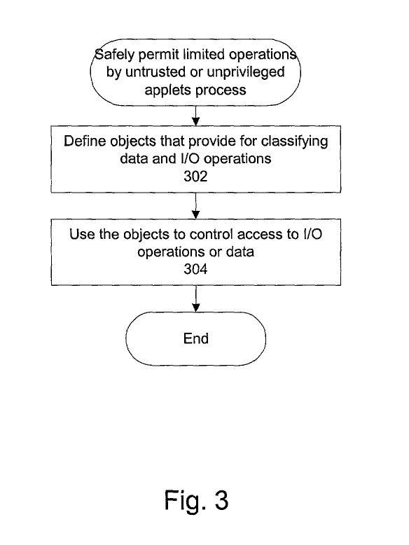

FIG. 3 illustrates the process for safely permitting limited operations by untrusted or unprivileged applets in an object-oriented computer system. A method is provided for safely permitting limited operations by untrusted or unprivileged applets in an object-oriented computer system. At step 302 objects are defined that provide for classifying data and methods performing input operations or output operations on the data to limit access to the input operations, the output operations or the data. At step 304 the objects are then used to control access to the input operations, the output operations or the data.

A first form of access to I/O that may be granted to an unprivileged applet through an opaque object is the ability to transfer data from one device to another, without any ability to examine the content of the data that is being moved. This is achieved by strictly limiting the types of input and output that are available through the opaque object that handles the I/O operations, and by making sure that the internal data itself is marked as “private” or “privileged”, so it cannot be accessed by unprivileged applets.

An example in which this form of access to an object would permit relatively safe I/O is in the case of displaying images. Using an opaque object that permits display of images, an applet would be permitted to fetch an image from any of a variety of sources, such as over a network, or from a local file system or other local I/O device that may provide an image. Images acquired in this manner could then be immediately transferred by the applet to the user's display. In accordance with the present invention, the opaque object that grants the ability to acquire and display images would not permit the actual data associated with the image to be accessed or manipulated by an unprivileged applet. Since the applet can only transfer the image data directly to the display, where it will be visible to the user, and cannot access the image data, the applet is unable to steal the data for its own use or to alter or damage the image data. Additionally, since the opaque object only permits the applet to send the image output to the user's screen, the applet in unable to damage or compromise the file or other source from which the image was loaded.

In addition to being able to output the image to the user's screen, the applet may be given access to some non-sensitive characteristics of the image, such as its image format (i.e. JPEG, GIF, etc.), its dimensions, and its average color. None of these characteristics is likely to permit an unprivileged applet to capture any particularly valuable or sensitive information about the image.

It should be noted that an applet should not be able to perform a screen capture so as to recover a copy of opaque image data. Applets should be prevented from directly reading display memory, and should instead be required to request that any application, applet, or graphical object that is having its images captured by a screen capture should provide images for the screen capture. An opaque image object should then provide a gray block to represent its data in a screen capture, thereby preventing an applet from using a screen capture to recover a copy of sensitive image data.

Printing of opaque objects, such as opaque image objects, may also raise issues. Often printers are shared between several members of a workgroup, so sending output to a printer is not necessarily safe. Before an applet may print, it should be required to inform the user that it is going to send output to the printer, and acquire the user's permission. Additionally, to prevent an applet from getting permission to print data which is non-sensitive, and using that permission to print sensitive opaque data after the non-sensitive data are printed, the printout notice that is provided to the user should specify a variety of information on what is being printed, such as the number of pages that will be printed. Further, a time limit on any particular print job started by an applet may be imposed to prevent an applet from delaying the unexpected printout of sensitive data following a legitimate print job.

Generally, transfers of data in which the data are immediately output in a manner that is visible or otherwise perceptible to the user, such as in the image display example described above, or audio playback, may be safely permitted for opaque data. As long as the applet or mobile code is given no other access to the data that it is transferring in this manner, there is no way for the applet to alter the data or covertly steal the data. Because the set of permitted output devices involve only display of the data, it would be difficult for the applet to cause any permanent damage to the user's data through use of the permitted output. Thus, even if the input data were sensitive, the limited nature of the output, and the lack of access to the data itself, make the transfer safe.

Some transfers of data may be more sensitive, depending on the nature of the output device to which the transfer is being made. If the output is to another site on the network, for example, then the operation is not safe (since such output could be used to steal data), and the opaque object that provides access to I/O should either not provide a capability to perform such output, or should give the user the ability to decide on-the-fly whether such output will be permitted.

A second example in which such an opaque object might be used to permit applets or mobile code to access I/O operations is use of a microphone on a client computer to record audio for later playback. There are many applets in which the ability, for example, to attach audio annotations recorded by the applet's user would be very useful. Permitting an applet or other mobile code to access a microphone connected to a user's computer, however, presents some clear means of abuse. For example, if not restricted, an applet could turn on the microphone on a user's computer without informing the user, and transmit everything that the microphone picks up across the Internet to an eavesdropper.

In accordance with the present invention, an opaque object may be used to make such I/O using a microphone less risky. If access to the microphone for unprivileged applets were controlled by an opaque object, the opaque object could make sure that the user is warned before the microphone is turned on, and that the user receives indicators, such as a flashing indicator on the screen, to remind him that the microphone is still running. Similarly, the opaque object could prevent the applet from getting access to the audio data, by making the data itself “private” or “privileged”, and could restrict the output options, by failing to provide a transfer mode that permits unprivileged applets to send the audio data encapsulated in the opaque object over a network.

In this microphone example, as in the previous example, the input and output of the data are both handled by an opaque object, which encapsulates and hides the actual audio data from the applet. The opaque object is the only way that the object can receive input from the microphone, and the only way that output from the microphone can be output. The applet has no way to turn on the microphone without the user knowing, and no way to send audio data collected through the microphone to an eavesdropper. As with opaque images, certain non-sensitive attributes of the audio data, such as its volume level or length, might be open for reading by an unprivileged applet.

The opaque objects of the present invention work by permitting unprivileged applets to access only certain selected I/O methods and data. Unprivileged applets are afforded no means of accessing any of the methods or data of an opaque object that have been tagged as “private” or “privileged.”

A number of rules may be followed in selection of the methods and data that should be accessible through an opaque object, to help ensure that I/O operations by unprivileged applets are kept safe. Input sources can be classified as sensitive or non-sensitive, depending on whether the input source is likely to permit unassisted access to sensitive information. Inputs may also be classified as loud or silent, depending on whether the user would know (without other notice) that the input is being collected.

Outputs may be classified as low risk, or high risk, depending on the nature of the output. Typically, the user's display, or other output device that will alert the user that the output is occurring would be classified as low risk, while outputs that the user may not be aware are occurring, such as network transfers, would be classified as high risk. Additionally, outputs may be classified as immediate or delayed, depending on when the output is displayed, played, or otherwise conveyed to the user, in relation to when the input is collected. An immediate output would happen essentially immediately upon reading the input, while a delayed output may be output some time after the input occurred. Generally, saving data to a file is considered delayed output, since the file will not be displayed, played, or otherwise conveyed to a user until some time after the input data was collected. This distinction is important because delayed outputs may provide a greater opportunity for data to be stolen or misused than immediate outputs provide.

If the input is classified as non-sensitive, then there is no reason to restrict what the applet can do with the input data, and an opaque object is probably not needed to control access to the I/O operations on that input. If the input is classified as sensitive, then an opaque object may be used to permit an unprivileged applet to perform some limited I/O operations with data collected from that input.

If an input is both sensitive and silent, then the opaque object may optionally take steps to ensure that the user is aware that the input is being collected, such as displaying indications on the screen that the input is being taken, and/or insisting that the use give consent to initiating the input. These steps may not be appropriate in every case, but are to be taken where there is a real danger of the user not knowing that sensitive input is being collected for possible high risk or delayed output.

For sensitive input sources, if the output is high risk, the opaque object should either be disallowed, or should be allowed only with express permission from the user. Similarly, if the output is delayed, then the opaque object should disallow the output, or permit it only in cases where the user is informed and approves at the time that the input is collected, at the time the data is output, or both. Only in cases where the output is low risk and immediate should sensitive input generally be permitted by the opaque object.

In some cases, on systems that provide access to multiple users, delayed output of sensitive data should be disallowed, unless the opaque object can verify that the identity of the user when the data was acquired is the same as the identity of the user when the data is later output. This verification may be accomplished by placing a user ID tag on any delayed opaque data object, such as an opaque data object that is stored on a disk. When an applet later outputs the opaque data object with a user ID tag, the applet checks that the user ID of the current user is the same as the user ID recorded in the opaque data object. For example, this prevents an applet from using the microphone to record audio from a user for later playback, and having a different user later play back the audio.

Applying these rules to the examples given above, in the case of displaying an image, the input may be sensitive, but the output to the display is low risk, and immediate, so output to the display is permitted. Output to a user across a network would be high risk, and is not permitted, and output to a file would be delayed, and so is not permitted (unless the user is queried for permission).

In the case of handling audio from a microphone, the input is sensitive and silent, and given the nature of the input, and the potential for eavesdropping, the opaque object should inform the user that the microphone is on. Since the information may be sensitive, the opaque object that handles the I/O to the microphone should not permit high risk output, such as sending the output over the Internet.

In addition to classifying the types of input and output to determine how to handle I/O in an Opaque Object, the data collected or information related to the data or computed from the data by the opaque object should also be classified as either accessible, or locked. Most data that comes from a sensitive input source will be locked, and will be completely inaccessible to any unprivileged applet. For example, the image data in the image example is locked, as is the audio data from the microphone example. If the applet were permitted to access such data, it could circumvent the other protections provided by handling I/O through the opaque object. Non-sensitive characteristics of the data, such as the dimensions of an image, may be made accessible.

In some instances, the data may be made accessible, while certain characteristics of the data are locked. For example, an opaque file opening object may display a dialog box to obtain information from the user about the location and name of the file to be opened and made accessible to the applet. Once this information is obtained from the user, the opaque file opening object would deliver an I/O stream for the file to the applet. The applet would get the contents of the file, but may not learn information that is kept locked in the opaque object, such as the file name or its directory. As seen in this example, sometimes the sensitive information that should be protected by the opaque object is the source or destination of the data, rather than the data itself.

Opaque I/O of the type described herein may also be used to let unprivileged applets set up network connections, such as in a peer-to-peer system. For example, a peer-to-peer applet could set up connections with people who have registered with a peer-to-peer “broker”. The “broker” would send the applet opaque objects pointing to the participants which represent network connections with the other participants. The applet could send or receive data through the opaque objects, but would not be permitted to access information on the identities or network addresses of the other participants.

It should be noted that at times when an opaque object must confirm a grant of access, or otherwise interact with a user, a system is needed to make certain that the user's responses are not synthesized, or otherwise generated by an applet that might be attempting to gain access to otherwise inaccessible I/O operations or data. This can be done in accordance with the principles of the present invention by marking each user interface event (such as mouse clicks, or keyboard entries) as either “authentic” or “synthetic”. Authentic events are generated by the underlying operating system, while synthetic events were generated by an applet. In cases where an opaque object requires input from the user before granting access to I/O, the input must consist of authentic events. If synthetic events were accepted as evidence of user input, an applet could circumvent many of the protections provided by the opaque objects of the present inventions by synthesizing any needed grants of permission.

The opaque I/O objects described hereinabove can be used in a variety of mobile code systems to permit unprivileged applets to perform a wide variety of I/O operations in a safe manner. Such opaque objects permit limited I/O without requiring the user of an applet to confer trust or privilege on the applet, and without exposing the user to a risk of his data being destroyed, compromised, or stolen by malicious applets.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for safely permitting limited operations by untrusted or unprivileged applets in an object-oriented computer system, comprising:
defining objects that provide for classifying data and methods performing input operations or output operations on the data to limit access to the input operations, the output operations or the data; and
using the objects to control access to the input operations, the output operations or the data.

2. The method of claim 1 wherein the object-oriented computer system is a mobile code computer system.

3. The method of claim 1 wherein the control comprises restricting access to at least one of the input operations, the output operations and the data.

4. The method of claim 1 wherein the control comprises notifying a user prior to accessing to at least one of the input operations, the output operations and the data.

5. The method of claim 1 wherein the control comprises receiving authorization from a user prior to accessing to at least one of the input operations, the output operations and the data.

6. The method of claim 1 wherein the input operations are classified as sensitive or non-sensitive.

7. The method of claim 1 wherein the input operations are classified as loud or silent.

8. The method of claim 1 wherein the output operations are classified as low- risk or high-risk.

9. The method of claim 1 wherein the output operations are classified as immediate or delayed.

10. The method of claim 1 wherein the data is classified as accessible or locked.

11. The method of claim 1 further comprising using the objects to control access to the input operations or the output operations and the data through events.

12. The method of claim 11 wherein the events are classified as authentic or synthetic.
